(19) United States
(12) Patent Application Publication
(10) Pub. No.: US 2024/0086951 A1
(43) Pub. Date: Mar. 14, 2024

(54) SATISFACTION LEVEL CALCULATION DEVICE, SATISFACTION LEVEL CALCULATION METHOD, AND COMPUTER READABLE MEDIUM

(71) Applicants: Mitsubishi Electric Corporation, Tokyo (JP); WASEDA UNIVERSITY, Tokyo (JP)

(72) Inventors: Noriko TAKAHASHI, Tokyo (JP); Kazuki HAMADA, Tokyo (JP); Masanori HASHIMOTO, Tokyo (JP); Yosuke KANEKO, Tokyo (JP); Shinichi TANABE, Tokyo (JP); Hiroaki NAGASHIMA, Tokyo (JP)

(73) Assignees: Mitsubishi Electric Corporation, Tokyo (JP); WASEDA UNIVERSITY, Tokyo (JP)

(21) Appl. No.: 18/509,424

(22) Filed: Nov. 15, 2023

Related U.S. Application Data
(63) Continuation of application No. PCT/JP2021/025291, filed on Jul. 5, 2021.

(51) Int. Cl. G06Q 30/0203

(52) U.S. Cl. CPC G06Q 30/0203

(57) ABSTRACT

A satisfaction level calculation device (10) acquires environmental data detected by each of a plurality of environment sensors (20). The satisfaction level calculation device (10) sets each of a plurality of indexes about a space environment as a target index. The satisfaction level calculation device (10) calculates, from the environmental data acquired by measuring the target index, an individual satisfaction level, which is a satisfaction level of the target index. The satisfaction level calculation device (10) calculates, from the individual satisfaction level about each of the plurality of indexes, an overall satisfaction level, which is an overall satisfaction level about the space environment.

### CROSS REFERENCE TO RELATED APPLICATION

This application is a Continuation of PCT International Application No. PCT/JP2021/025291, filed on Jul. 5, 2021, which is hereby expressly incorporated by reference into the present application.

### TECHNICAL FIELD

The present disclosure relates to a technique of making evaluation of a space environment.

### BACKGROUND ART

In recent years, for controlling various electrical household appliances such as air-conditioning devices and lighting devices, a method of calculating a user's environment-related satisfaction level, such as a thermal-environment satisfaction level or a light-environment satisfaction level, has been suggested.

Patent Literature 1 describes a method for air-conditioning control devices by using Predicted Mean Vote (hereinafter PMV) calculated from six factors: activity amount, clothing insulation, room temperature, humidity, indoor air speed, and average radiant temperature.

### CITATION LIST

### Patent Literature

Patent Literature 1: WO 2019/026998

### SUMMARY OF INVENTION

### Technical Problem

By calculating MTV, it is possible to specify a user's satisfaction level about the thermal environment. However, only with a satisfaction level for a single environmental index such as the satisfaction level about the thermal environment, a user's satisfaction level with mutual influences of a plurality of environmental indexes is uncertain.

For example, even if the user is satisfied with the thermal environment alone or the light environment alone, the user may be dissatisfied with an environment where the thermal environment and the light environment mutually influence each other, for example, lighting has a warm color as a light environment and degrades the thermal environment. In this case, only with the satisfaction level about the thermal environment, it is uncertain that the user is dissatisfied. That is, it cannot be said that the conventional index of the satisfaction level with respect to a single environment appropriately indicates the user's satisfaction level with respect to the environment.

The present disclosure has as its object to allow a user's appropriate satisfaction level with respect to an environment to be found.

### Solution to Problem

A satisfaction level calculation device according to the present disclosure includes:
an individual calculating unit to calculate, from environmental data acquired by taking each of a plurality of indexes about a space environment as a target index and measuring the target index, an individual satisfaction level, which is a satisfaction level of the target index; and
an overall calculating unit to calculate, from the individual satisfaction level about each of the plurality of indexes calculated by the individual calculating unit, an overall satisfaction level, which is an overall satisfaction level about the space environment.

### Advantageous Effects of Invention

In the present disclosure, an overall satisfaction level, which is an overall level of satisfaction, is calculated based on an individual satisfaction level of each of a plurality of indexes about the environment. With this, a user's appropriate satisfaction level with respect to the environment can be found.

### BRIEF DESCRIPTION OF DRAWINGS

FIG. 1 is a diagram of structure of a satisfaction level calculation system 100 according to Embodiment 1.

FIG. 2 is a diagram of structure of a satisfaction level calculation device 10 according to Embodiment 1.

FIG. 3 is a flowchart illustrating operation of the satisfaction level calculation device 10 according to Embodiment 1.

FIG. 4 is a diagram describing an environmental data storage unit 51 according to Embodiment 1.

FIG. 5 is a diagram describing a satisfaction level storage unit 52 according to Embodiment 1.

FIG. 6 is a diagram of structure of the satisfaction level calculation device 10 according to Modification 2.

FIG. 7 is a diagram of structure of the satisfaction level calculation system 100 according to Embodiment 2.

FIG. 8 is a diagram of structure of the satisfaction level calculation device 10 according to Embodiment 2.

FIG. 9 is a flowchart illustrating operation of the satisfaction level calculation device 10 according to Embodiment 2.

FIG. 10 is a diagram describing a display screen according to Embodiment 2.

FIG. 11 is a diagram describing a display screen according to Modification 4.

FIG. 12 is a diagram of structure of the satisfaction level calculation system 100 according to Embodiment 3.

FIG. 13 is a diagram of structure of the satisfaction level calculation device 10 according to Embodiment 3.

FIG. 14 is a flowchart illustrating operation of the satisfaction level calculation device 10 according to Embodiment 3.

FIG. 15 is a diagram of structure of the satisfaction level calculation system 100 according to Embodiment 4.

FIG. 16 is a diagram of structure of the satisfaction level calculation device 10 according to Embodiment 4.

FIG. 17 is a flowchart illustrating operation of the satisfaction level calculation device 10 according to Embodiment 4.

FIG. 18 is a diagram of structure of the satisfaction level calculation system 100 according to Embodiment 5.

FIG. 19 is a diagram of structure of the satisfaction level calculation device 10 according to Embodiment 5.

FIG. 20 is a flowchart illustrating operation of the satisfaction level calculation device 10 according to Embodiment 5.

### DESCRIPTION OF EMBODIMENTS

### Embodiment 1

### ***Description of Structure***

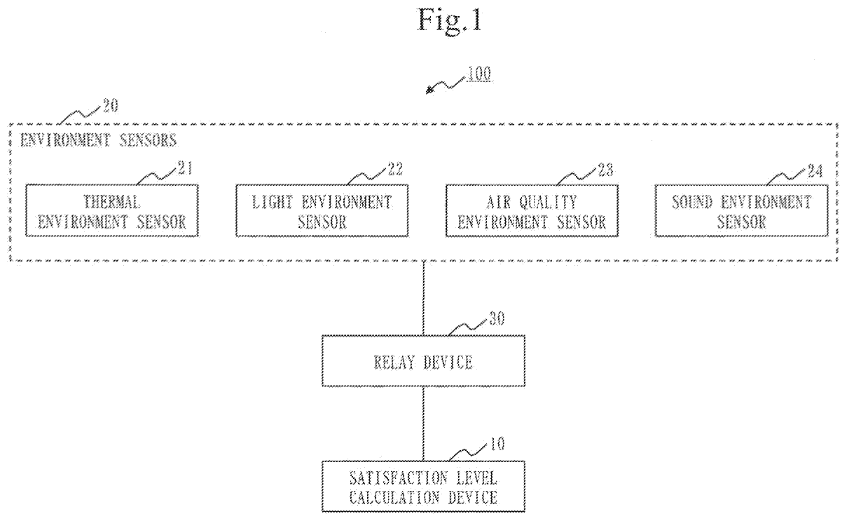

With reference to FIG. 1, the structure of a satisfaction level calculation system according to Embodiment 1 is described.

The satisfaction level calculation system 100 includes a satisfaction level calculation device 10, environment sensors 20 regarding a plurality of indexes, and a relay device 30. The satisfaction level calculation device 10 is connected to the relay device 30 via a transmission path. The relay device 30 is connected to each environment sensor 20 via transmission paths.

The satisfaction level calculation device 10 is a computer which calculates a user's satisfaction level about a space environment. The environment sensors 20 are devices which detect environmental data about environmental indexes. The relay device 30 is a device which transmits the environmental data detected by each environment sensor 20 to the satisfaction level calculation device 10.

In Embodiment 1, the satisfaction level calculation system 100 includes, as the environment sensors 20, a thermal environment sensor 21, a light environment sensor 22, an air quality environment sensor 23, and a sound environment sensor 24.

The thermal environment sensor 21 detects environmental data about a thermal environment. As a specific example, the thermal environment sensor 21 is a thermometer, a hygrometer, or a PMV meter. The light environment sensor 22 detects environmental data about a light environment. As a specific example, the light environment sensor 22 is an illuminometer or a luminance meter. The air quality environment sensor 23 detects environmental data about air quality. As a specific example, the air quality environment sensor 23 is a carbon dioxide meter. The sound environment sensor 24 detects environmental data about a sound environment. As a specific example, the sound environment sensor 24 is a sound pressure meter.

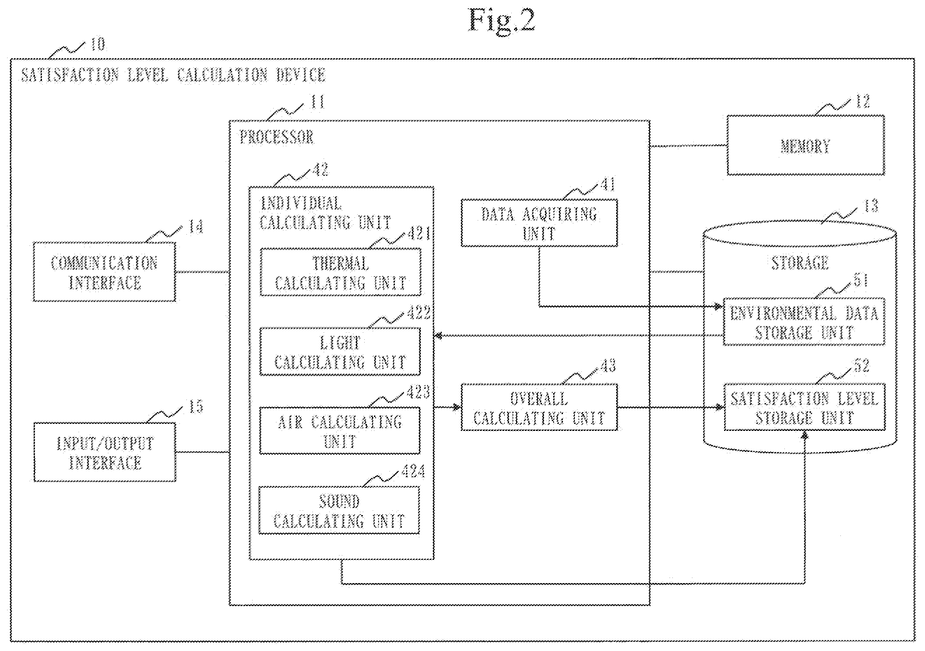

With reference to FIG. 2, the structure of the satisfaction level calculation device 10 according to Embodiment 1 is described.

The satisfaction level calculation device 10 is a computer.

The satisfaction level calculation device 10 includes hardware including a processor 11, a memory 12, a storage 13, a communication interface 14, and an input/output interface 15. The processor 11 is connected to other pieces of hardware via a signal line to control these other pieces of hardware.

The processor 11 is an IC (Integrated Circuit) performing processing. As a specific example, the processor 11 is a CPU (Central Processing Unit), a DSP (Digital Signal Processor), or a GPU (Graphics Processing Unit).

The memory 12 is a storage device which temporarily stores data. As a specific example, the memory 12 is an SRAM (Static Random Access Memory) or a DRAM (Dynamic Random Access Memory).

The storage 13 is a storage device which retains data. As a specific example, the storage 13 is an HDD (Hard Disk Drive). Also, the storage 13 may be a portable recording median, such as an SD (registered trademark, Secure Digital), a memory card, a CF (CompactFlash, registered trademark), a NAND flash, a flexible disk, an optical disk, a compact disk, a Blu-ray (registered trademark) disk, or a DVD (Digital Versatile Disk).

The communication interface 14 is an interface for communicating with an external device. As a specific example, the communication interface 14 is a port of Ethernet (registered trademark).

The input/output interface 15 is an interface for connecting an input device and an output device together. As a specific example, the input/output interface 15 is a port of a USB (Universal Serial Bus) or HDMI (registered trademark, High-Definition Multimedia Interface).

The satisfaction level calculation device 10 includes a data acquiring unit 41, an individual calculating unit 42, and an overall calculating unit 43 as functional components. In Embodiment 1, the individual calculating unit 42 includes a thermal calculating unit 421, a light calculating unit 422, an air calculating unit 423, and a sound calculating unit 424. The functions of each functional component of the satisfaction level calculation device 10 are implemented by software.

In the storage 13, a program implementing the functions of each functional component of the satisfaction level calculation device 10 is stored. This program is read by the processor 11 into the memory 12 and executed by the processor 11. With this, the functions of each functional component of the satisfaction level calculation device 10 are implemented.

Also, the storage 13 implements an environmental data storage unit 51 and a. satisfaction level storage unit 52.

In FIG. 2, only one processor 11 is illustrated. However, a plurality of processors 11 may be provided, and the plurality of processors 11 may execute, in a coordinated fashion, a program implementing each function.

### ***Description of Operation***

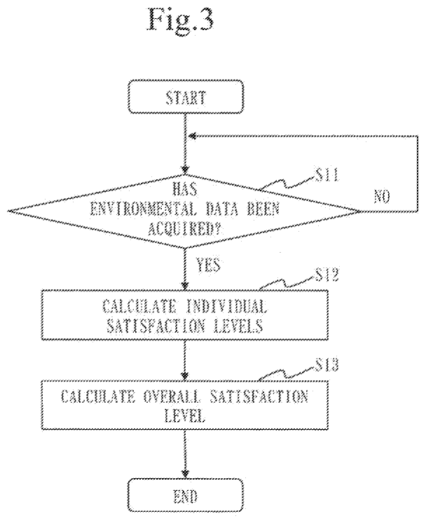

With reference to FIG. 3, the operation of the satisfaction level calculation device 10 according to Embodiment 1 is described.

The operation procedure of the satisfaction level calculation device 10 according to Embodiment 1 is equivalent to a satisfaction level calculation method according to Embodiment 1. Also, a program implementing the operation of the satisfaction level calculation device 10 according to Embodiment 1 is equivalent to a satisfaction level calculation program according to Embodiment 1.

### (Step S11 of FIG. 3: Environmental Data Acquiring Process)

The data acquiring unit 41 acquires environmental data detected by each environment sensor 20 via the relay device 30.

Specifically, each environment sensor 20 transmits the detected environmental data to the relay device 30. Then, the relay device 30 transmits the environmental data transmitted from each environment sensor 20 to the satisfaction level calculation device 10. The data acquiring unit 41 acquires the environmental data transmitted from the relay device 30.

When acquiring all pieces of environmental data detected at all of the environment sensors 20, the data acquiring unit 41 causes the process to proceed to step S12. That is, in Embodiment 1, when acquiring environmental data detected by the thermal environment sensor 21, environmental data detected by the light environment sensor 22, environmental data detected by the air quality environment sensor 23, and environmental data detected by the sound environment sensor 24, the data acquiring unit 41 causes the process to proceed to step S12. On the other hand, if there is environmental data not acquired, the data acquiring unit 41 waits until that environmental data can be acquired.

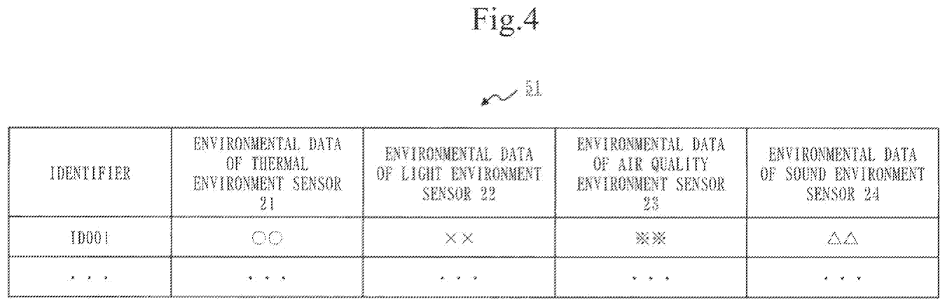

As illustrated in FIG. 4, the data acquiring unit 41 assigns an identifier to a set of the pieces of environmental data detected at the environment sensors 20 and writes them in the environmental data storage unit 51.

### (Step S12 of FIG. 3: Individual Calculating Process)

The individual calculating unit 42 sets each of a plurality of indexes about the space environment as a target index. In Embodiment 1, the individual calculating unit 42 sets each of four indexes, that is, a thermal index, a light index, an air quality index, and a sound index, as a target index. From the environmental data acquired by measuring the target index, the individual calculating unit 42 calculates an individual satisfaction level, which is a satisfaction level of the target index.

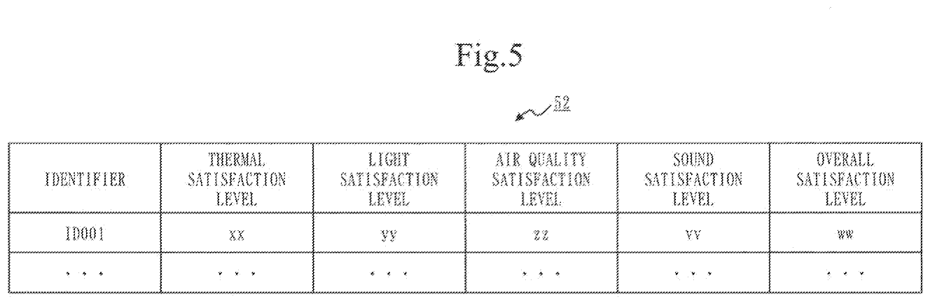

As illustrated in FIG. 5, the individual calculating unit 42 writes each calculated individual satisfaction level in the satisfaction level storage unit 52 together with the identifier assigned to the environmental data at step S11.

Specifically, the thermal calculating unit 421 calculates, from the environmental data detected by the thermal environment sensor 21, a thermal satisfaction level, which is a satisfaction level about the thermal index, as an individual satisfaction level. The thermal satisfaction level is a value indicating a user's satisfaction level with respect to thermal sense, such as hot or cold, based on temperature, humidity, or the like.

For example, the thermal calculating unit 421 calculates a thermal satisfaction level with an expression of thermal satisfaction level=temperature×a+b. Here, a and b are parameters. a and b are set from previous data with a scheme such as multiple regression analysis, or are specified by the user.

Also, the light calculating unit 422 calculates, from the environmental data detected by the light environment sensor 22, a light satisfaction level, which is a satisfaction level about the light index, as an individual satisfaction level. The light satisfaction level is a value indicating a user's satisfaction level with respect to the space or work in a light environment including not only brightness such as bright or dark but also hue, chroma, and so forth.

For example, the light calculating unit 422 calculates a light satisfaction level with an expression of light satisfaction level=luminance×c+illuminance×d+e. Here, c, d, and e are parameters. c, d, and e are set from previous data with a scheme such as multiple regression analysis, or are specified by the user.

Also, the air calculating unit 423 calculates, from the environmental data detected by the air quality environment sensor 23, an air quality satisfaction level, which is a satisfaction level about the air quality index, as an individual satisfaction level. The air quality satisfaction level is a value indicating a user's satisfaction level with respect to air quality such as a carbon dioxide concentration. Note that the air quality satisfaction level may be calculated also in consideration of the temperature, humidity, and so forth detected by the thermal environment sensor 21.

For example, the air calculating unit 423 calculates an air quality satisfaction level with an expression of air quality satisfaction level =carbon dioxide concentration×f+g. Here, f and g are parameters. f and g are set from previous data with a scheme such as multiple regression analysis, or are specified by the user.

Also, the sound calculating unit 424 calculates, from the environmental data detected by the sound environment sensor 24, a sound satisfaction level, which is a satisfaction level about the sound index, as an individual satisfaction level. The sound satisfaction level is a value indicating a user's satisfaction level with respect to sound, such as the magnitude of noise.

For example, the sound calculating unit 424 calculates a sound satisfaction level with an expression of sound satisfaction level=acoustic feature sound×h+i. Here, h and i are parameters. h and i are set from previous data with a scheme such as multiple regression analysis, or are specified by the user. In the acoustic feature sound, features of sound, such as sound pressure and tone, are defined by numerical values.

### (Step S13 of FIG. 3: Overall Calculating Process)

The overall calculating unit 43 calculates, from the individual satisfaction level about each of the plurality of indexes calculated at step S12, an overall satisfaction level, which is an overall satisfaction level about a space environment.

In Embodiment 1, the overall calculating unit 43 calculates an overall satisfaction level from the thermal satisfaction level, the light satisfaction level, the air quality satisfaction level, and the sound satisfaction level. Specifically, the overall calculating unit 43 weights the thermal satisfaction level, the light satisfaction level, the air quality satisfaction level, and the sound satisfaction level and then adds together, thereby calculating an overall satisfaction level.

For example, the overall calculating unit 43 calculates an overall satisfaction level with an expression of overall satisfaction level=thermal satisfaction level×j+light satisfaction level×k+air satisfaction level×l+sound satisfaction level×m+n. Here, j, k, l, m, and n are parameters. j, k, l, m, and n are set from previous data with a scheme such as multiple regression analysis, or are specified by the user.

As illustrated in FIG. 5, the overall calculating unit 43 writes the calculated overall satisfaction level into a record of the satisfaction level storage unit 52 having the individual satisfaction levels written at step S12.

Note that a case can be also thought in which individual satisfaction levels and an overall satisfaction level of each of a plurality of spaces are calculated. In this case, the satisfaction level calculation device 10 performs the process illustrated in FIG. 3 on each of the plurality of spaces as a target to calculate individual satisfaction levels and an overall satisfaction level of each of the plurality of spaces.

### ***Effects of Embodiment 1***

As described above, the satisfaction level calculation device 10 according to Embodiment 1 calculates an overall satisfaction level, which is an overall level of satisfaction, based on each of the individual satisfaction levels of the plurality of indexes about the environment. With this, a user's appropriate satisfaction level with respect to the environment can be found.

### ***Other Structures***

### Modification 1

In Embodiment 1, the individual calculating unit 42 sets each of four indexes, that is, the thermal index, the light index, the air quality index, and the sound index, as a target index to calculate four individual satisfaction levels, that is, a thermal satisfaction level, a light satisfaction level, an air quality satisfaction level, and a sound satisfaction level. Then, the overall calculating unit 43 calculates an overall satisfaction level from these four individual satisfaction levels.

However, the individual calculating unit 42 is not limited to use these four as individual satisfaction levels. The satisfaction level calculation device 10 may use only part of these four individual satisfaction levels or may use individual satisfaction levels other than these four. Then, the overall calculating unit 43 is only required to calculate an overall satisfaction level from two or more individual satisfaction levels calculated by the individual calculating unit 42.

As individual satisfaction levels other than these four, there are, fir example, a space-congestion satisfaction level, which is a user's satisfaction level with respect to a person or substance occupying a space, and a greening satisfaction level, which is a user's satisfaction level with respect to foliage plants placed in a space.

### Modification 2

In Embodiment 1, each functional component is implemented by software. However, as Modification 2, each functional component may be implemented by hardware. As for this Modification 2, description is made on points different from Embodiment 1.

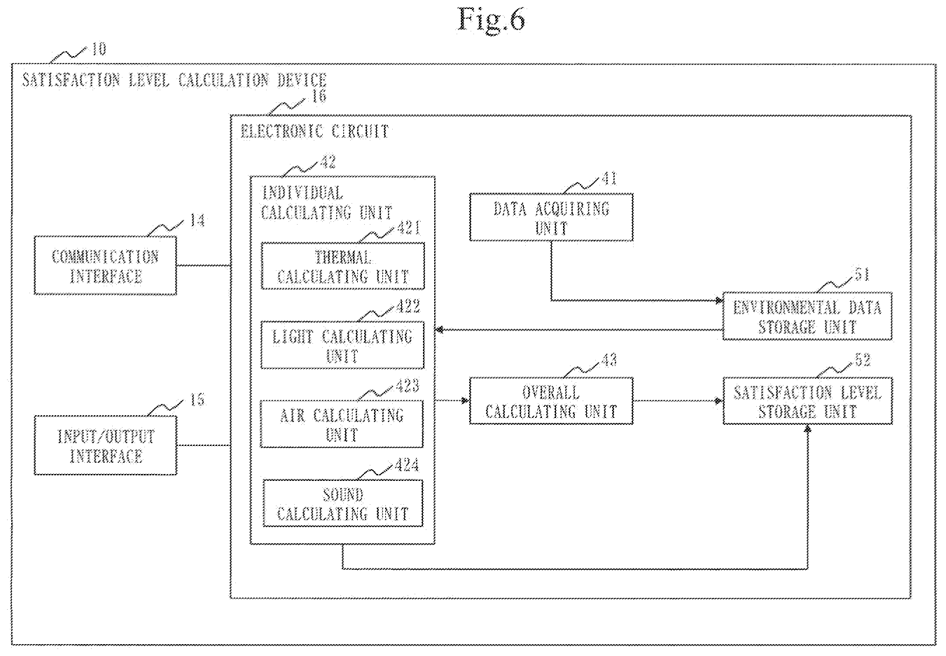

With reference to FIG. 6, the structure of the satisfaction level calculation device 10 according to Modification 2 is described.

When each functional component is implemented by hardware, the satisfaction level calculation device 10 includes an electronic circuit 16 in place of the processor 11, the memory 12, and the storage 13. The electronic circuit 16 is a dedicated circuit implementing the functions of each functional component, the memory 12, and the storage 13.

As the electronic circuit 16, a single circuit, a composite circuit, a programmed processor, a parallel-programmed processor, a logic IC, a GA (Gate Array), an ASIC (Application Specific integrated Circuit), or an FPGA (Field-Programmable Gate Array) is assumed.

Each functional component may be implemented by one electronic circuit 16, or each functional component may be implemented as being distributed into a plurality of electronic circuits 16.

### Modification 3

As Modification 3, some functional components may be implemented by hardware and the other functional components may be implemented by software.

The processor 11, the memory 12, the storage 13, and the electronic circuit 16 are referred to as a processing circuitry. That is, the functions of each functional component are implemented by the processing circuitry.

### Embodiment 2

Embodiment 2 is different from Embodiment 1 in that an overall satisfaction level calculated by the overall calculating unit 43 is displayed. In Embodiment 2, this different point is described and description of the same points is omitted.

### ***Description of Structure***

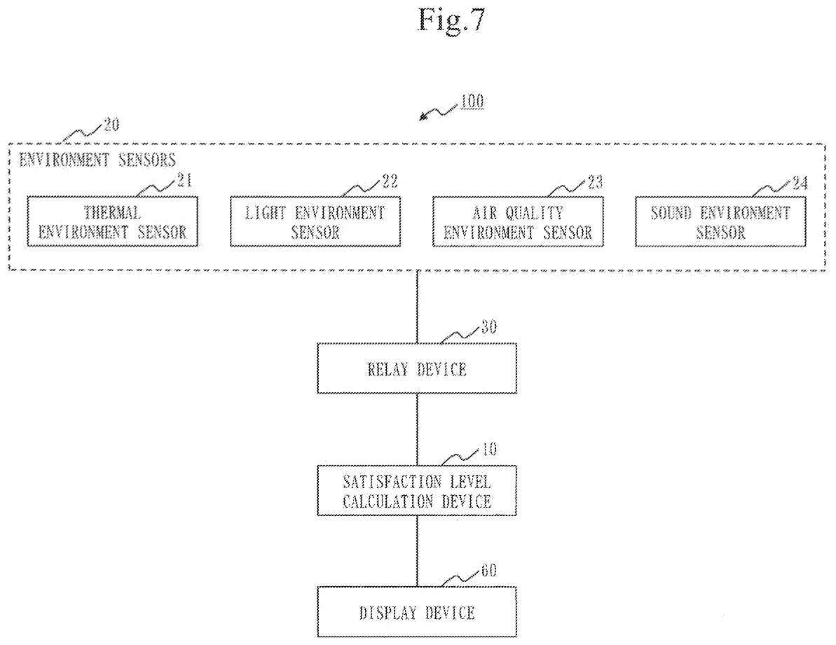

With reference to FIG. 7, the structure of the satisfaction level calculation system 100 according to Embodiment 2 is described.

The satisfaction level calculation system 100 is different from the satisfaction level calculation system 100 illustrated in FIG. 1 in that a display device 60 is included. The display device 60 is a device which visualizes information, such as an LCD (Liquid Crystal Display).

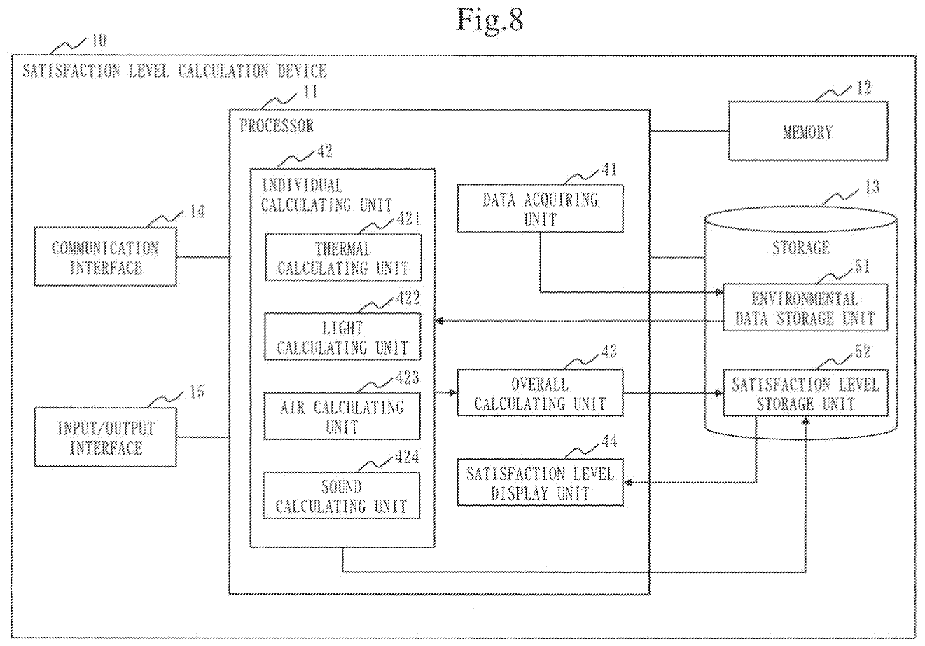

With reference to FIG. 8, the structure of the satisfaction level calculation device 10 according to Embodiment 2 is described.

The satisfaction level calculation device 10 is different from the satisfaction level calculation device 10 illustrated in FIG. 2 in that a satisfaction level display unit 44 is included as a functional component. As with the other functional components, the functions of the satisfaction level display unit 44 are implemented by software or hardware.

### ***Description of Operation***

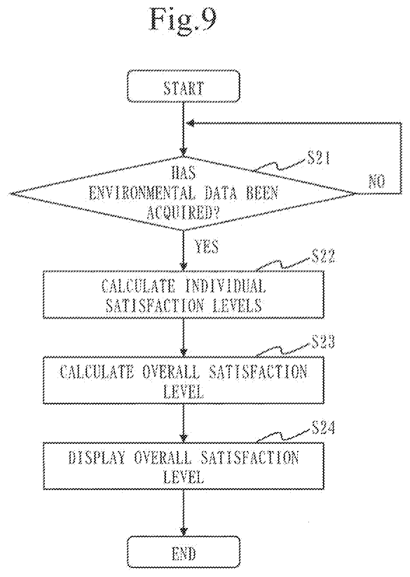

With reference to FIG. 9 to FIG. 11, the operation of the satisfaction level calculation device 10 according to Embodiment 2 is described.

The operation procedure of the satisfaction level calculation device 10 according to Embodiment 2 is equivalent to a satisfaction level calculation method according to Embodiment 2. Also, a program implementing the operation of the satisfaction level calculation device 10 according to Embodiment 2 is equivalent to a satisfaction level calculation program according to Embodiment 2.

The process at step S21 to step S23 of FIG. 9 is identical to the process at step S11 to step S13 of FIG. 3.

### (Step S24 of FIG. 9: Display Process)

The satisfaction level display unit 44 causes a display screen representing the overall satisfaction level calculated at step S23 to be displayed on the display device 60.

Specifically, the satisfaction level display unit 44 reads the overall satisfaction level from the satisfaction level storage unit 52, processes it into a display screen, and then transmits the display screen to the display device 60 for display. Here, the satisfaction level display unit 44 may cause also the individual satisfaction levels calculated at step S22 to be displayed together on the display device 60. That is, the satisfaction level display unit 44 may read not only the overall satisfaction level but also the individual satisfaction levels from the satisfaction level storage unit 52, process them into a display screen, and then transmit the display screen to the display device 60 for display.

As a specific example, the satisfaction level display unit 44 may cause a display screen representing time-series graphs indicating time-series changes of the overall satisfaction level and each individual satisfaction level to be displayed on the display device 60. For each individual satisfaction level, the satisfaction level display unit 44 may generate a display screen representing not a time-series graph but a current value.

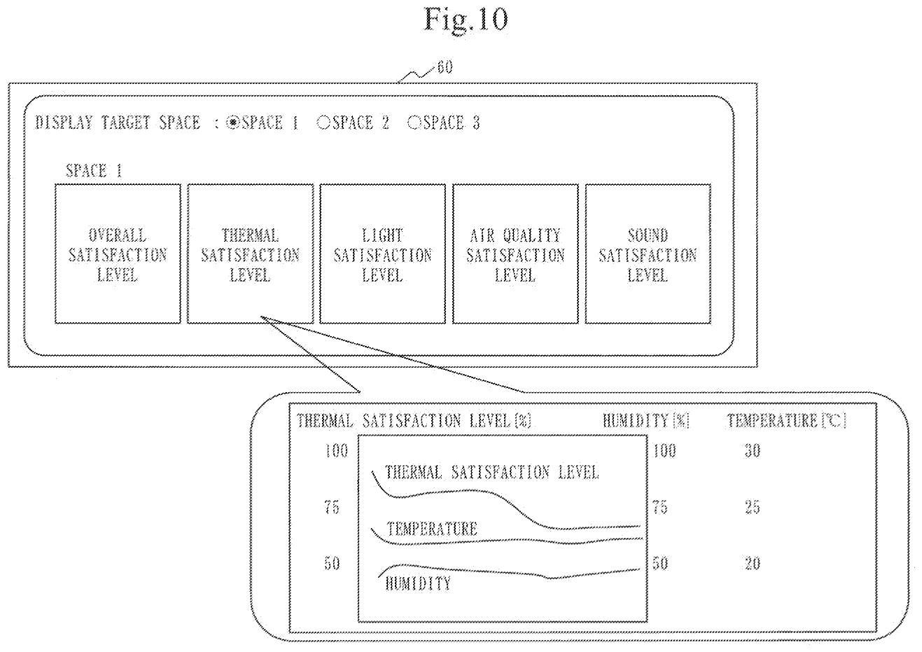

Note that a case can be also thought in which individual satisfaction levels and an overall satisfaction level of each of a plurality of spaces are calculated. In this case, as illustrated in FIG. 10, the satisfaction level display unit 44 generates, for each space, a display screen representing time-series graphs of the overall satisfaction level and each individual satisfaction level. Then, the satisfaction level display unit 44 causes the display screen of the specified space to be displayed on the display device 60.

### ***Effects of Embodiment 2***

As described above, the satisfaction level calculation device 10 according to Embodiment 2 causes the overall satisfaction level and so forth to be displayed on the display device 60. With this, by checking the display device 60, the user's satisfaction level with respect to the environment can be checked. As a result, it is possible to appropriately determine a method of controlling the device for controlling the space environment.

### ***Other Structures***

### Modification 4

In Embodiment 2, when individual satisfaction levels and an overall satisfaction level of each of the plurality of spaces are calculated, a display screen is generated for each space.

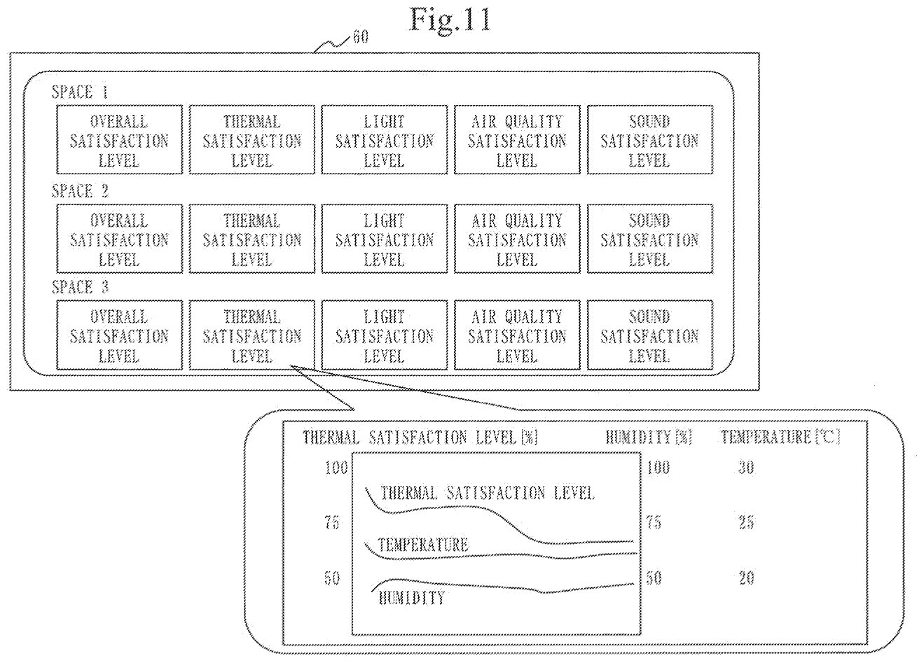

However, as illustrated in FIG. 11, the satisfaction level display unit 44 may generate a display screen representing an overall satisfaction level of each of the plurality of spaces. Specifically, the satisfaction level display unit 44 provides a separate display area for each space, and sets time-series graphs of the overall satisfaction level and each individual satisfaction level for each space in their corresponding display areas. With this, the satisfaction level display unit 44 generates a display screen in which time-series graphs of the overall satisfaction level and each individual satisfaction level of each of the plurality of spaces are displayed. Then, the satisfaction level display unit 44 causes this display screen to be displayed on the display device 60.

With this, for the plurality of spaces, the user's satisfaction levels with respect to the environment can be checked all at once.

### Embodiment 3

Embodiment 3 is different from Embodiments 1 and 2 in that a method of controlling a device 70 that influences the space environment is determined in accordance with the overall satisfaction level. In Embodiment 3, this different point is described and description of the same points is omitted.

In Embodiment 3, a case is described in which a function is added to Embodiment 1. However, it is possible to add a function to Embodiment 2.

### ***Description of Structure***

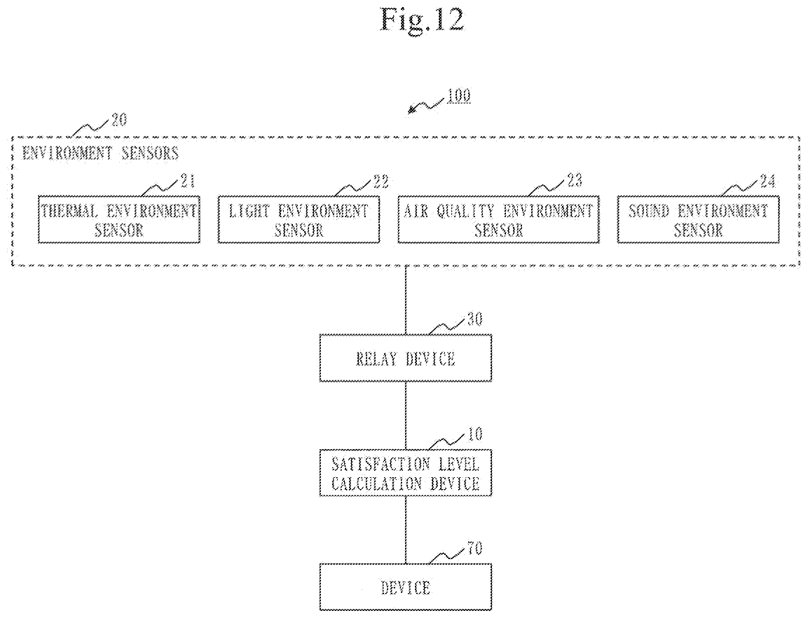

With reference to FIG. 12, the structure of the satisfaction level calculation system 100 according to Embodiment 3 is described.

The satisfaction level calculation system 100 is different from the satisfaction level calculation system 100 illustrated in FIG. 1 in that the device 70 is included. The device 70 is a controllable device which influences the space environment. As a specific example, the device 70 is an air-conditioning device, a lighting device, a ventilating device, or an acoustic device. Note that the satisfaction level calculation system 100 desirably includes the device 70 which influences two or more environmental indexes. This is because, by including the device 70 which influences two or more environmental indexes, it is possible to adjust a plurality of individual satisfaction levels and easily improve the overall satisfaction level.

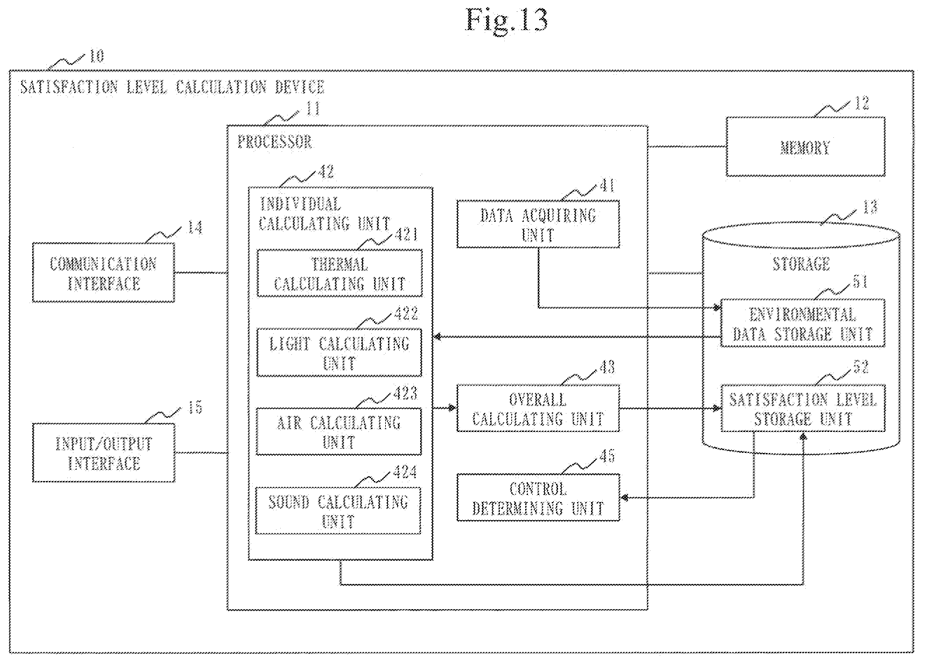

With reference to FIG. 13, the structure of the satisfaction level calculation device 10 according to Embodiment 3 is described.

The satisfaction level calculation device 10 is different from the satisfaction level calculation device 10 illustrated in FIG. 2 in that a control determining unit 45 is included as a functional component. As with the other functional components, the functions of the control determining unit 45 are implemented by software or hardware.

### ***Description of Operation***

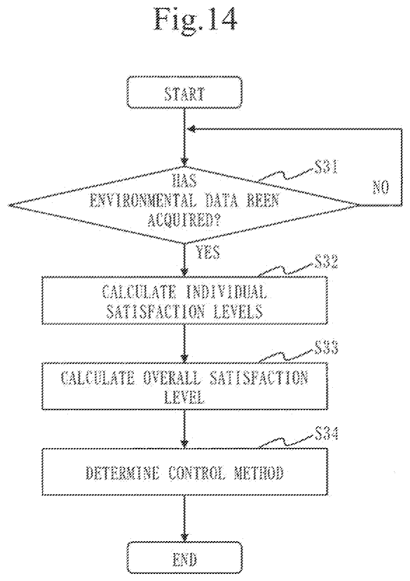

With reference to FIG. 14, the operation of the satisfaction level calculation device 10 according to Embodiment 3 is described.

The operation procedure of the satisfaction level calculation device 10 according to Embodiment 3 is equivalent to a satisfaction level calculation method according to Embodiment 3. Also, a program implementing the operation of the satisfaction level calculation device 10 according to Embodiment 3 is equivalent to a satisfaction level calculation program according to Embodiment 3.

The process at step S31 to step S33 of FIG. 14 is identical to the process at step S11 to step S13 of FIG. 3.

### (Step S34 of FIG. 14: Control Determining Process)

The control determining unit 45 determines a method of controlling the device 70 which influences the space environment in accordance with the overall satisfaction level calculated at step S33. Here, the control determining unit 45 may determine a method of controlling the device 70 in consideration of the individual satisfaction levels calculated at step S32.

Specifically, the control determining unit 45 determines whether the overall satisfaction level is equal to or smaller than a threshold. The threshold is assumed to be determined in advance and stored in the storage 13. When the overall satisfaction level is equal to or smaller than the threshold, the control determining unit 45 determines, as a control method, a method causing the overall satisfaction level to become higher than the threshold. Here, the control determining unit 45 may determine, as a control method, a method causing also each individual satisfaction level to become higher than a threshold. On the other hand, when the overall satisfaction level is higher than the threshold, the control determining unit 45 determines that the current control method is maintained.

A specific example of the method of determining a control method is described.

As illustrated in FIG. 4, in the environmental data storage unit 51, environmental data is stored for each identifier. As illustrated in FIG. 5, in the satisfaction level storage unit 52, the individual satisfaction levels and the overall satisfaction level are stored for each identifier. The environmental data as calculation sources and the calculated individual satisfaction levels and overall satisfaction level are assigned with the same identifier. Here, the environmental data and the individual satisfaction levels and overall satisfaction level assigned with the same identifier are assumed to be one set.

With reference to the environmental data storage unit 51 and the satisfaction level storage unit 52, the control determining unit 45 specifies a set in which the overall satisfaction level is higher than the threshold and the environmental data about each of the plurality of indexes is close to the current space environment. The environmental data about each of the plurality of indexes being close to the current space environment means that, for example, for all indexes, the value indicated by the environmental data is within a reference range from a value about the current space environment. The reference range may be defined for each index. Then, the control determining unit 45 determines, as a control method, a method causing the state of the space environment to become close to a state indicated by the environmental data in the specified set.

Note that the method of determining a control method is not limited to this method and machine learning using a convolutional neural network or the like may be used. With this, when a control method is determined, satisfaction levels are taken as inputs, and an optimal method of controlling the device 70 can be determined by machine learning.

### ***Effects of Embodiment 3***

As described above, the satisfaction level calculation device 10 according to Embodiment 3 determines a method of controlling the device which influences the space environment in accordance with the overall satisfaction level. With this, it is possible to keep the space in a state comfortable for the user.

### ***Other Structures***

### Modification 5

In Embodiment 3, when the overall satisfaction level is equal to or smaller than the threshold, the control determining unit 45 specifies a set in which the overall satisfaction level is higher than the threshold and the environmental data about each of the plurality of indexes is close to the current space environment. Then, the control determining unit 45 determines, as a control method, a method causing the state of the space environment to become close to a state indicated by the environmental data in the specified set.

As Modification 5, the control determining unit 45 may specify a set in which the overall satisfaction level is the highest in a previous certain period. Then, the control determining unit 45 may determine, as a control method, a method causing the state of the space environment to become close to a state indicated by the environmental data in the specified set. The certain period may be a period specified by the user or a period specified in accordance with the environment such as any of the four seasons.

Specifically, the control determining unit 45 determines whether there is a set in which the overall satisfaction level in the previous certain period is higher than the overall satisfaction level calculated at step S33. If there is a set in which the overall satisfaction level in the previous certain period is higher, the control determining unit 45 specifies a set in which the overall satisfaction level is the highest in the previous certain period. Then, the control determining unit 45 determines, as a control method, a method causing the state of the space environment to become close to the state indicated by the environmental data in the specified set.

The control determining unit 45 may specify a set in which not the overall satisfaction level but a specific individual satisfaction level is the highest and determine, as a control method, a method causing the state of the space environment to become close to the state indicated by the environmental data in the specified set. Alternatively, the control determining unit 45 may specify a set in which each individual satisfaction level and the overall satisfaction level are all the highest and determine, as a control method, a method causing the state of the space environment to become close to the state indicated by the environmental data in the specified set. Alternatively, the control determining unit 45 may specify a set in which an average value of each individual satisfaction level and the overall satisfaction level is the highest and determine, as a control method, a method causing the state of the space environment to become close to the state indicated by the environmental data in the specified set. Alternatively, the control determining unit 45 may specify a set in which the number of the highest satisfaction levels among each individual satisfaction level and the overall satisfaction level is the highest and determine, as a control method, a method causing the state of the space environment to become close to the state indicated by the environmental data in the specified set.

### Embodiment 4

Embodiment 4 is different from Embodiment 3 in that a control method is determined in consideration of consumed power. In Embodiment 4, this different point is described and description of the same points is omitted.

### ***Description of Structure***

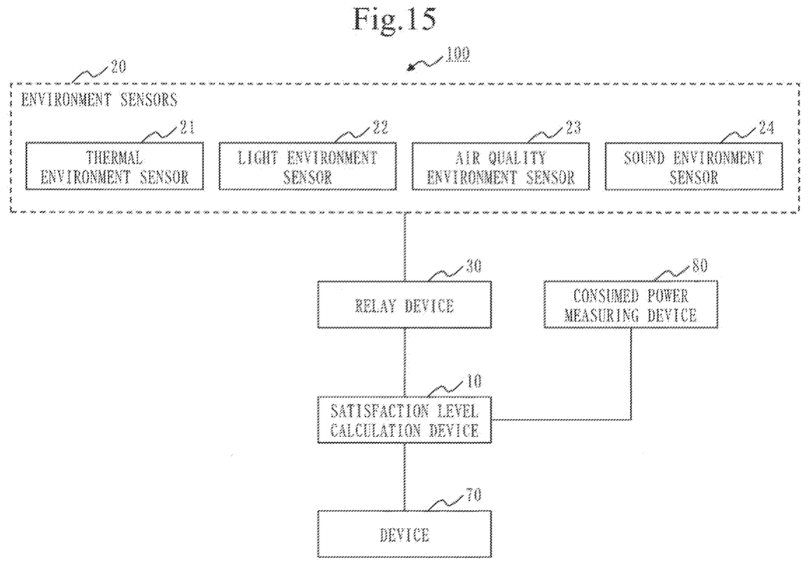

With reference to FIG. 15, the structure of the satisfaction level calculation system 100 according to Embodiment 4 is described.

The satisfaction level calculation system 100 is different from the satisfaction level calculation system 100 illustrated in FIG. 12 in that a consumed power measuring device 80 is included. The consumed power measuring device 80 is a device which measures consumed power of each device 70 and consumed power of the entire building configuring a space.

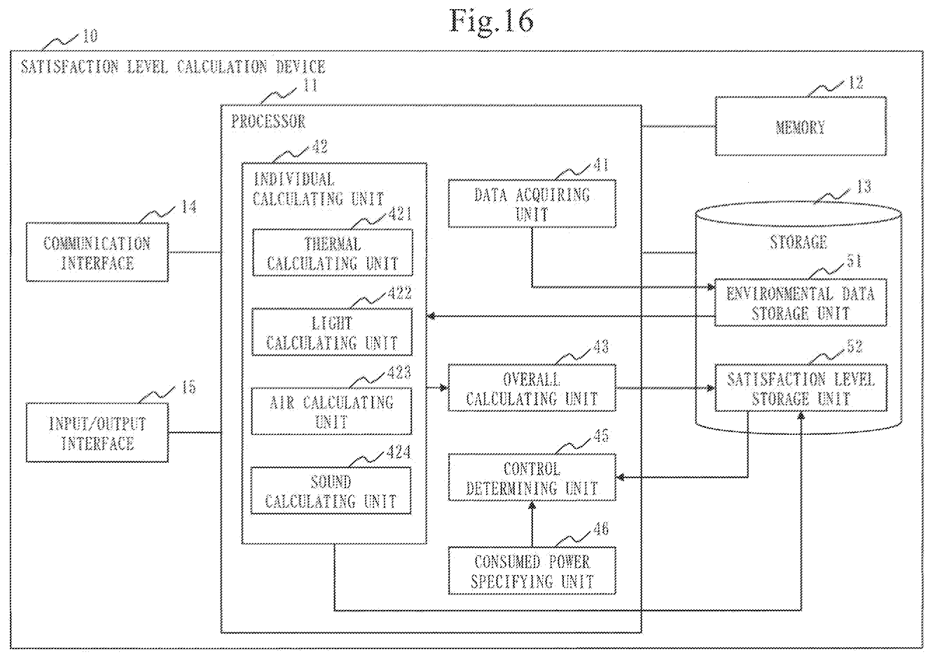

With reference to FIG. 16, the structure of the satisfaction level calculation device 10 according to Embodiment 4 is described.

The satisfaction level calculation device 10 is different from the satisfaction level calculation device 10 illustrated in FIG. 13 in that a consumed power specifying unit 46 is included as a functional component. As with the other functional components, the functions of the consumed power specifying unit 46 are implemented by software or hardware.

### ***Description of Operation***

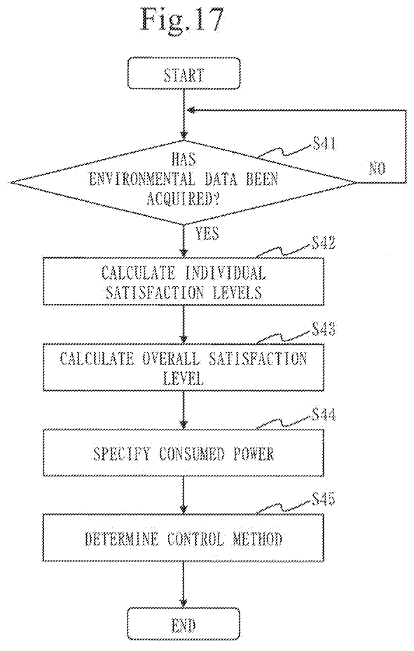

With reference to FIG. 17, the operation of the satisfaction level calculation device 10 according to Embodiment 4 is described.

The operation procedure of the satisfaction level calculation device 10 according to Embodiment 4 is equivalent to a satisfaction level calculation method according to Embodiment 4. Also, a program implementing the operation of the satisfaction level calculation device 10 according to Embodiment 4 is equivalent to a satisfaction level calculation program according to Embodiment 4.

The process at step S41 to step S43 of FIG. 17 is identical to the process at step S31 to step S33 of FIG. 14.

### (Step S44 of FIG. 17: Consumed Power Specifying Process)

The consumed power specifying unit 46 acquires consumed power of each device 70 and consumed power of the entire building configuring a space measured by the consumed power measuring device 80. The consumed power specifying unit 46 specifies a device 70 with consumed power exceeding a reference value from among devices 70. The reference value may be defined for each device 70.

### (Step S45 of FIG. 17: Control Determining Process)

The control determining unit 45 determines a method of controlling the device 70 which influences the space environment in accordance with the consumed power specified at step S44.

Specifically, the control determining unit 45 determines a control method by taking the individual satisfaction levels calculated at step S42, the overall satisfaction level calculated at step S43, and the consumed power acquired at step S44 as inputs.

First, the control determining unit 45 determines whether the overall satisfaction level is equal to or smaller than a threshold.

When the overall satisfaction level is equal to or smaller than the threshold, the control determining unit 45 determines a control method in a manner similar to that at step S34 of FIG. 14. When there are a plurality of methods in which the overall satisfaction level is higher than the threshold, the control determining unit 45 may determine, as a control method, a method in which the consumed power is the smallest.

When the overall satisfaction level is higher than the threshold, while maintaining the current overall satisfaction level, the control determining unit 45 determines, as a control method, a method causing the consumed power to decrease. For example, while maintaining the overall satisfaction level, the control determining unit 45 determines, as a control method, a method capable of causing the consumed power of the device 70 with consumed power exceeding the reference value at step S44 to decrease. As a specific example, it is assumed that an air-conditioning device is in cooling operation and the consumed power of the air-conditioning device exceeds the reference value. In this case, control is performed in which, while the setting temperature of the air-conditioning device is increased to decrease consumed power, the hue of lighting by a lighting device is changed to a color which makes people feel cool. With this, while the overall satisfaction level is maintained, the consumed power can be decreased.

Note that the method of determining a control method is not limited to this method and machine learning using a convolutional neural network or the like may be used. With this, when a control method is determined, the satisfaction levels and the consumed power are taken as inputs, and an optimal method of controlling the device 70 can be determined by machine learning.

### ***Effects of Embodiment 4***

As described above, the satisfaction level calculation device 10 according to Embodiment 4 determines a control method in consideration of consumed power. With this, while keeping the space in a state comfortable for the user, it is possible to reduce consumed power.

### Embodiment 5

Embodiment 5 is different from Embodiments 1 to 4 in that the satisfaction level is calculated in consideration of the subjective sense of a user using a space. In Embodiment 5, this different point is described and description of the same points is omitted.

In Embodiment 5, a case is described in which a function is added to Embodiment 1. However, it is possible to add a function to Embodiments 2 to 4.

### ***Description of Structure***

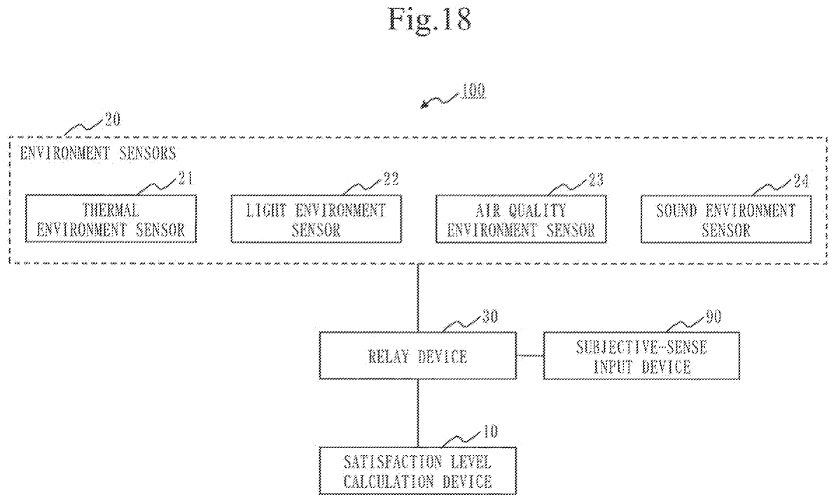

With reference to FIG. 18, the structure of the satisfaction level calculation system 100 according to Embodiment 5 is described.

The satisfaction level calculation system 100 is different from the satisfaction level calculation system 100 illustrated in FIG. 1 in that a subjective-sense input device 90 is included. The subjective-sense input device 90 is a terminal such as a PC (Personal Computer) and smartphone for use by a space user.

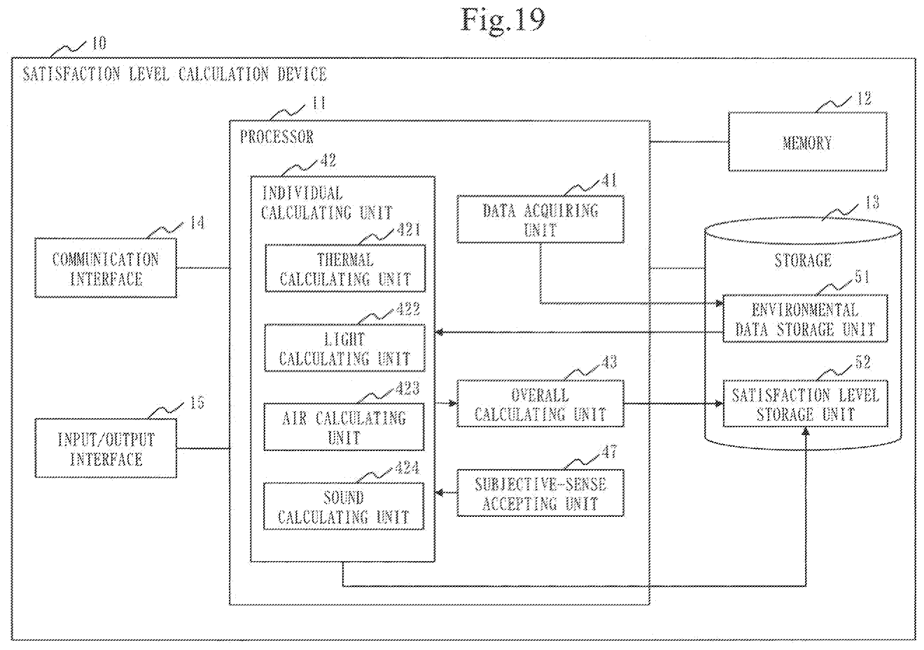

With reference to FIG. 19, the structure of the satisfaction level calculation device 10 according to Embodiment 5 is described.

The satisfaction level calculation device 10 is different from the satisfaction level calculation device 10 illustrated in FIG. 2 in that a subjective-sense accepting unit 47 is included as a functional component. As with the other functional components, the functions of the subjective-sense accepting unit 47 are implemented by software or hardware.

### ***Description of Operation***

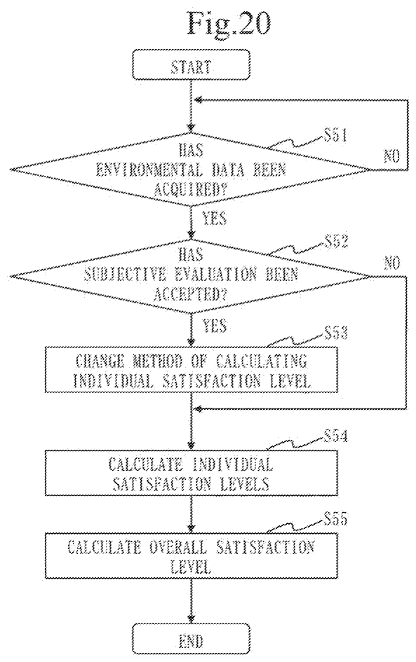

With reference to FIG. 20, the operation of the satisfaction level calculation device 10 according to Embodiment 5 is described.

The operation procedure of the satisfaction level calculation device 10 according to Embodiment 5 is equivalent to a satisfaction level calculation method according to Embodiment 5. Also, a program implementing the operation of the satisfaction level calculation device 10 according to Embodiment 5 is equivalent to a satisfaction level calculation program according to Embodiment 5.

The process at step S51 of FIG. 20 is identical to the process at step S11 of FIG. 3. The process at step S54 and step S55 of FIG. 20 is identical to the process at step S12 and step S13 of FIG. 3.

### (Step S52 of FIG. 20: Subjective-Sense Accepting Process)

The subjective-sense accepting unit 47 determines whether a subjective evaluation has been newly inputted. If a subjective evaluation has been newly inputted, the subjective-sense accepting unit 47 acquires the inputted subjective evaluation, and causes the process to proceed to step S53. On the other hand, if a subjective evaluation has not been newly inputted, the subjective-sense accepting unit 47 causes the process to proceed to step S54.

Here, by taking each of the plurality of indexes as an evaluation index, a subjective evaluation indicating whether the current state is satisfactory for each evaluation index is inputted by the user to the subjective-sense input device 90. For example, as tier the thermal environment, when the current state is appropriate, a subjective evaluation indicating the state is satisfactory is inputted. When the current state is hot or cold, a subjective evaluation indicating that the state is unsatisfactory is inputted. Then, the subjective-sense input device 90 transmits the subjective evaluation to the satisfaction level calculation device 10. When the subjective evaluation is transmitted from the subjective-sense input device 90, the subjective-sense accepting unit 47 takes the subjective evaluation as newly inputted and acquires the subjective evaluation, and causes the process to proceed to step S53.

### (Step S53 of FIG. 20: Calculation Method Changing Process)

With the subjective evaluation accepted at step S52, the individual calculating unit 42 changes the method of calculating the individual satisfaction level about each of the plurality of indexes. Also, with the subjective evaluation accepted at step S52, the overall calculating unit 43 changes the method of calculating the overall satisfaction level.

Specifically, with the subjective evaluation accepted at step S52, the individual calculating unit 42 changes parameters at the time of calculating the individual satisfaction level. For example, the individual calculating unit 42 changes parameters at the time of calculating the individual satisfaction level by conducting multiple regression analysis by using evaluation indexes previously accepted. Similarly, with the subjective evaluation accepted at step S52, the overall calculating unit 43 changes the parameters (a to i) at the time of calculating the overall satisfaction level. For example, the overall calculating unit 43 changes the parameters (j to n) at the time of calculating the overall satisfaction level by conducting multiple regression analysis by using evaluation indexes previously accepted.

Note that the method of changing parameters is not limited to this method, and a determination may be automatically made by using machine learning using a convolutional neural network or the like.

### ***Effects of Embodiment 5***

As described above, the satisfaction level calculation device 10 according to Embodiment 5 changes the method of calculating a satisfaction level based on the evaluation by the subjective sense of the user. With this, the subjective sense of the user is reflected on satisfaction level calculation, making it possible to more appropriately calculate a satisfaction level.

Note that “unit” in the above description may be read as “circuit”, “step”, “procedure”, “process”, or “processing circuit”.

In the foregoing, the embodiments and the modifications of the present disclosure have been described. Some of these embodiments and modifications may be combined for implementation. Also, any one or some of these embodiments and modifications may be partially implemented. Note that the present disclosure is not limited to the above embodiments and modifications and can be variously changed as required.

### REFERENCE SIGNS LIST

100: satisfaction level calculation system; 10: satisfaction level calculation device; 11: processor; 12: memory; 13: storage; 14: communication interface; 15: input/output interface; 16: electronic circuit; 20: environment sensor; 21: thermal environment sensor; 22: light environment sensor; 23: air quality environment sensor; 24: sound environment sensor; 30: relay device; 41: data acquiring unit; 42: individual calculating unit; 421: thermal calculating unit; 422: light calculating unit; 423: air calculating unit; 424: sound calculating unit; 43: overall calculating unit; 44: satisfaction level display unit; 45: control determining unit; 46: consumed power specifying unit; 47: subjective-sense accepting unit; 51: environmental data storage unit; 52: satisfaction level storage unit; 60: display device; 70: device; 80: consumed power measuring device; 90: subjective-sense input device

1. A satisfaction level calculation device comprising:
processing circuitry to:
calculate, from a plurality of pieces of environmental data acquired by taking each of a plurality of indexes about a space environment as a target index and measuring the target index, an individual satisfaction level, which is a satisfaction level of the target index;
calculate, from the individual satisfaction level about each of the calculated plurality of indexes, an overall satisfaction level, which is an overall satisfaction level about the space environment; and
determine a method of controlling a device which influences the space environment causing the individual satisfaction level about each of the calculated plurality of indexes to become higher than a first threshold, and causing the calculated overall satisfaction level to become higher than a second threshold.

2. The satisfaction level calculation device according to claim 1, wherein
the processing circuitry displays a display screen representing the calculated overall satisfaction level.

3. The satisfaction level calculation device according to claim 2, wherein
the processing circuitry calculates the individual satisfaction level about each of a plurality of spaces,
calculates the overall satisfaction level about each of the plurality of spaces, and
displays the overall satisfaction level about each of the plurality of spaces.

4. The satisfaction level calculation device according to claim 1, wherein
the processing circuitry determines, as the control method, a method in which consumed power is small.

5. The satisfaction level calculation device according to claim 1, wherein
the processing circuitry takes each of the plurality of indexes as an evaluation index and to accept an input of a subjective evaluation, which is an evaluation about the evaluation index, and
with the accepted subjective evaluation, changes a method of calculating the individual satisfaction level.

6. The satisfaction level calculation device according to claim 1, wherein
the processing circuitry changes a method of calculating the individual satisfaction level by machine learning.

7. A satisfaction level calculation method comprising:
from a plurality of pieces of environmental data acquired by taking each of a plurality of indexes about a space environment as a target index and measuring the target index, calculating an individual satisfaction level, which is a satisfaction level of the target index;
from the individual satisfaction level about each of the plurality of indexes, calculating an overall satisfaction level, which is an overall satisfaction level about the space environment; and
determining a method of controlling a device which influences the space environment causing the individual satisfaction level about each of the plurality of indexes to become higher than a first threshold, and causing the overall satisfaction level to become higher than a second threshold.

8. A non-transitory computer readable medium storing a satisfaction level calculation program that causes a computer to function as a satisfaction level calculation device to perform:
an individual calculating process of calculating, from a plurality of pieces of environmental data acquired by taking each of a plurality of indexes about a space environment as a target index and measuring the target index, an individual satisfaction level, which is a satisfaction level of the target index;
an overall calculating process of calculating, from the individual satisfaction level about each of the plurality of indexes calculated by the individual calculating process, an overall satisfaction level, which is an overall satisfaction level about the space environment; and
a control determining process of determining a method of controlling a device which influences the space environment causing the individual satisfaction level about each of the plurality of indexes calculated by the individual calculating process to become higher than a first threshold, and causing the overall satisfaction level calculated by the overall calculating process to become higher than a second threshold.
